(19) United States
(12) Patent Application Publication
(10) Pub. No.: US 2008/0163793 A1
(43) Pub. Date: Jul. 10, 2008

(54) METHOD OF INHIBITING NITROSAMINE FORMATION IN WATERBORNE COATING

(75) Inventors: Michael D. Gernon, Phoenixville, PA (US); Conor M. Dowling, Ambler, PA (US)

Correspondence Address: SUGHRUE MION, PLLC, 2100 PENNSYLVANIA AVENUE, N.W., SUITE 800, WASHINGTON, DC, 20037, US

(73) Assignee: TAMINCO, Gent (BE)

(21) Appl. No.: 11/871,467

(22) Filed: Oct. 12, 2007

Related U.S. Application Data
(60) Provisional application No. 60/851,611, filed on Oct. 13, 2006.

(51) Int. Cl. C09D 7/12

(52) U.S. Cl. 106/287.26; 106/287.3

(57) ABSTRACT

A method is provided for inhibiting the formation of nitrosamines in water based coating formulations containing secondary and/or tertiary amines and a nitrosating agent comprising adding to the system an inhibiting amount of a primary amine. The method includes the addition of a small quantity of primary amine to a waterborne coating formulation that contains a tertiary and/or secondary amine neutralizing agent and a nitrosating agent whereby the formation of nitrosamines is suppressed to a degree that renders it insignificant.

### FIELD OF THE INVENTION

The present invention relates to novel methods of controlling nitrosamine formation in waterborne coatings, and more particularly to methods of adding primary amines to waterborne coating formulations which contain materials with the potential to form nitrosamines. The invention also relates to the obtained waterborne coating formulations. BACKGROUND OF THE INVENTION

Some types of nitrosamines have been shown to be carcinogenic in tests using laboratory animals. In general, all nitrosamines are presumed to be carcinogenic unless they've been tested and shown to be relatively harmless. For example, nitrosamines with tertiary butyl or two benzyl groups attached to the nitrogen reportedly are not carcinogenic in test animals. Nitrosamines are often generated as undesired byproducts in certain foods (especially bacon) and cosmetic and hygiene products (such as shampoo and hair conditioner). Nitrosamines are also present in various other fluids that can come into contact with the skin, such as metal-working fluids (which are used to cool and/or lubricate metal pieces during machining processes), hydraulic fluids, pesticides, waterborne coatings such as paints and various other commercial chemicals.

Waterborne coatings formulations are oftentimes neutralized with amines to an optimal pH value. It is sometimes found that the best amine available for a given application is either a secondary or tertiary amine. Both secondary amines and tertiary amines can be nitrosated by nitrosating agents to yield nitrosamines. In the case of tertiary amines, the mechanism involves intermediate conversion of the tertiary amine to a secondary amine. The occurrence of significant levels of nitrosamines in commercial products is normally not accepted. Nitrosating agents are not present in many commercial coatings formulations, and both secondary and tertiary amines can be freely used in such “nitrosating-agent free” products. However, in coating formulations which contain nitrosating agents, formation of nitrosamines can become a concern where secondary and/or tertiary amines are used as pH control agents. The most typical nitrosating agents added to coatings formulations are nitrite salts such as sodium or potassium nitrite. Such nitrites are generally added as corrosion inhibitors. Formation of nitrosamine contaminants in such formulations usually results from the reaction of such nitrosating agents with secondary and/or tertiary amines. Nitrosation can occur during product preparation, either during heating or at moderate temperatures. It can also occur while a product sits on a shelf, especially if the product sits for months in a warehouse that becomes warm. Many efforts have been made to eliminate nitrosamines from various substances, or to reduce their concentrations to the lowest practical levels. In various types of food, the use of ascorbic acid (vitamin C) and alpha-tocopherol (vitamin E) and their salts is known to inhibit nitrosamine formation.

U.S. Pat. No. 6,495,065 discloses a composition for shortstopping free radical emulsion polymerization in which mono-(C2- C16)alkylamines, polyethylenimines (PEI) and their derivatives, pyrroles (or indoles) and their derivatives, hydroquinone (or catechol) and their derivatives, ascorbic acid and its derivatives, and polyoxymethylenes and their derivatives are added to inhibit nitrosamine formation. U.S. Pat. No. 5,087,671 discloses a method of scavenging nitrosating agents in which reactive groups bonded to polymer backbones are employed.

### SUMMARY OF THE INVENTION

It is an object of the present invention to provide a method of inhibiting the formation of nitrosamines in water based coating formulations and to provide water based coating formulations wherein the formation of nitrosamines is inhibited.

In accordance, with the present invention, there is provided a method for inhibiting the formation of nitrosamines in water based coating formulations containing secondary and/or tertiary amines and a nitrosating agent comprising adding to the formulation an inhibiting amount of a primary amine. This invention teaches that the use of a small quantity of primary amine mixed with a preferred tertiary or secondary amine neutralizing agent in a waterborne coating formulation suppresses the formation of nitrosamines to a degree that renders it insignificant.

### DESCRIPTION OF THE INVENTION

The present invention is directed to a method in which primary amines are added to waterborne coating formulations which include secondary and/or tertiary amines and nitrosating agents whereby formation of nitrosamines is inhibited.

The precise dosage of the nitrosamine inhibiting agents of this invention depends, to some extent, on the nature of the coating system in which it is to be incorporated and the degree of protection desired. In general, however, the concentration of primary amine added to the coating system will be from about 1% to about 100% by weight relative to the amount of secondary and/or tertiary amine. Within this range, dosages of about 10%-50% are preferred, with a dosage of about 25% or less being most preferred for many coating formulations, such as for example, latex paint formulations. The exact amount required with respect to a particular coating formulation can be readily determined by one of ordinary skill in the art in a conventional manner.

The total amount of primary amine added to a coating formulation will generally be between 1 ppm and 10,000 ppm by weight relative to the total weight of the coating, as the amount of secondary and/or tertiary amine added to a waterborne coating is typically between 100 ppm and 10,000 ppm.

The present invention relates to coating formulations incorporating secondary and/or tertiary amines wherein the secondary and/or tertiary amine is being added to the formulation for the primary purpose of neutralization and pH adjustment. The coating formulation contains at least a binder and water as the main vehicle. Suitable binders include oils or polymeric materials such as acrylics, polyurethanes, polyesters, melamine resins or epoxy. In general, the binder comprises a material different from rubber. In the method according to the invention the primary amine is preferably added to the formulation after having produced the binder, i.e. the primary amine is not used in the production of the binder. When the formulation is a paint, it additionally comprises at least one pigment. The waterborne coating formulation may however be free of pigments. The invention relates to primary amines wherein the equivalent weight based on neutralizing capacity is less than 300. Among the classes of primary and secondary/tertiary amines covered by the present invention are monoalkylamines and dialkylamines/trialkylamines, alkanolamines and N-alkylethanolamines/N-alkyldiethanolamines/N,N-dialkylethanolamines, alkylaminopropylamines and 3-substituted propylamines and/or arbitrary mixtures of the above. Typical examples of secondary and/or tertiary amines in accordance with the present invention include methylaminoethanol, ethylaminoethanol, isopropylaminoethanol, butylaminoethanol, methyldiethanolamine, ethyldiethanolamine, isopropyldiethanolamine, butyldiethanolamine, dimethylaminoethanol, diethylaminoethanol, diisopropylaminoethanol, dibutylaminoethanol, 3-dimethylaminopropylamine, 3-diethylaminopropylamine or mixtures thereof. Typical examples of primary amines in accordance with the present invention include monoethanolamine, 2-amino-2-methyl-1-propanol, 3-dimethylaminopropylamine, 3-diethylaminopropylamine or mixtures thereof. The primary amines have preferably a molecular weight smaller than 300 and are more preferably non-polymeric. They are water soluble so that they are dissolved in the waterborne formulation.

The nitrosating agents of the present invention include nitrite salts such as sodium nitrite and ammonium nitrite, N₂O₃ precursors, nitrosonium salts and nitrosyl halides. Other potential nitrosating agents would be controlled by the present invention. However, nitrite salts are most common in the waterborne coatings market.

The mechanism of nitrosamine formation inhibition is believed to be through interception of potential nitrosating agents by the primary amine. The principal nitrosating agent of concern in waterborne coatings is N₂O₃ produced by the dehydration of nitrous acid.

NO₂⁻+H⁺→HNO₂

2HNO₂→N₂O₃═H₂O

Dinitrogen trioxide produced from nitrite can react with secondary amines to yield stable nitroso compounds.

RNHR′+N₂O₃→RR′N—NO+HNO₂

When a primary amine is present in sufficient quantity, it will intercept dinitrogen trioxide to produce nontoxic byproducts.

RNH₂+N₂O₃→RNH—NO+HNO₂

RNHNO→RN═NOH (diazotic acid)

RN═NOH+H⁺H₂O+R—N≡N⁺(diazonium compound)

H₂O+R—N≡N⁺ROH+N₂(g)+H⁺

In the case of tertiary amines, various dealkylation mechanisms result in the formation of intermediate secondary amines that can then be nitrosated as set forth above.

The amount of primary amine necessary to insure that a sufficient amount of nitrosating agent is intercepted will vary depending on the specific coatings system employed, the amount of nitrite and the amount of secondary and/or tertiary amine. Typically, a treatment level between about 1% and about 100% by weight based on the amount of secondary/tertiary amine employed was found to be sufficient assuming, as is normally the case, that total nitrite levels are lower than the total amines level.

For the purposes of this disclosure, a primary amine is defined as a molecule containing at least one primary amino group (N bonded to two hydrogens and one alkyl or aryl group) (e.g., 2-amino-2-methy-1-propanol or monoethanolamine). A secondary amine is defined as a molecule containing at least one secondary amino group (nitrogen bonded to one hydrogen and two alkyl and/or aryl groups) (e.g., methylaminoethanol or Butylaminoethanol). A tertiary amine is defined as a molecule containing at least one tertiary amino group (N bonded to three alkyl and/or aryl groups) (e.g., triethanolamine or butyldiethanolamine).

### EXAMPLES

### Example 1

An emulsion concentrate was produced as given below:

72 grams of 100 SUS Type II petrochemical oil
72 grams of fatty acid diethanolamide
72 grams of sulfonated type 11 petrochemical oil
72 grams of tall oil fatty acids (5% rosin)
30 grams of 80% tri(2-hydroxyethyl)-s-triazine
24 grams of BASF 17R4 nonionic surfactant (product of BASF Corp.)
40 grams of Butylaminoethanol (secondary amine)
100 grams of triethanolamine (tertiary amine) dilution with DI water to 1 kilogram total weight.

A 5% aqueous emulsion of the above concentrate was made up. The quantity of nitroso compounds that formed in the above diluted emulsion was determined by extraction with an equal weight of methylene chloride (CH₂Cl₂ phase dried with MgSO₄) followed by a sensitive GC/MS analysis developed and calibrated with independently synthesized nitrosamine compounds (N-nitroso-N-butylethanolamine, 2 geometric isomers) and employing an internal thiodiglycol standard. Two grams per liter of sodium nitrite was added to the above diluted emulsion and it was allowed to sit at room temperature (app. 220 C) for 48 hours. No nitrosamine was observed. A 25 gram quantity of the nitrite treated emulsion was transferred to a small pressure vessel and heated at 120° C. for 48 hours. Observable quantities of nitrosamine were produced. The estimated rate of nitrosamine formation was 2 ppm per week for the first week. The addition of 0.1% monoethanolamine to the original concentrate (2.5% by weight relative to the amount of secondary amine) and heating at 120° C. for 48 hours resulted in complete suppression of nitrosamine formation.

### Example 2

An emulsion concentrate was prepared having the formulation:

72 grams of 100 SUS Type II petrochemical oil

72 grams of fatty acid diethanolamide

72 grams of sulfonated type 11 petrochemical oil

72 grams of tall oil fatty acids (5% rosin)

30 grams of 80% tri(2-hydroxyethyl)-s-triazine

24 grams of BASF 17R4 nonionic surfactant (product of BASF Corp.)

40 grams of Butylaminoethanol (secondary amine)

36 grams of triethanolamine (tertiary amine)

15 grams of monoethanolamine (primary amine) dilution with DI water to 1 kilogram total weight.

The emulsion concentrate (7.5 grams) was diluted to 5% by weight and divided into three equal 50 ml portions. The three portions were treated with 0 g/l, 1 g/l and 5 g/l of sodium nitrite respectively and allowed to age for 30 days. The samples were analyzed for nitrosamine content by GC/MS (gas chromatography—mass spectrometry—electrical ionization, quadrupole analyzer) and GC/NCD (gas chromatography—nitrogen chemiluminescence detector—aka thermal energy analyzer). Sample preparation for both analyses involved methylene chloride extraction and spiking with a TDG standard. No nitrosamine formation could be detected in any of the three solutions. The solutions were transferred to sealed containers and heated at 120° C. for three days followed by analysis according to the above methods. No nitrosamine formation was observed in any of the three solutions. When the same experiment was repeated with a concentrate containing no primary amine, the nitrite-free solution still displayed no nitrosamine formation after both room temperature (RT) and heat aging. The nitrite-containing solutions displayed no nitrosamine formation after RT aging, but the heat aged nitrite-containing solutions did exhibit nitrosamine formation (app. 30 ppm for the 1 g/l sodium nitrite solution and 50 ppm for the 5 g/l sodium nitrite solution). Certain catalysts like oxalic acid drastically increased the amount of nitrosamine formed in nitrite-containing solutions such as those described here.

### Example 3

An emulsion concentrate was prepared as follows:

72 grams of 100 SUS Type II petrochemical oil
72 grams of fatty acid diethanolamide
72 grams of sulfonated type 11 petrochemical oil
72 grams of tall oil fatty acids (5% rosin)
30 grams of 80% tri(2-hydroxyethyl)-s-triazine
24 grams of BASF 17R4 nonionic surfactant (product of BASF Corp.)
36 grams of monoethanolamine (primary amine)
36 grams of triethanolamine (tertiary amine) dilution with DI water to 1 kilogram total weight.

The concentrate was aged at RT (room temperature, app. 22° C.) for 6 months and then analyzed for nitroso-diethanolamine by a GC/NCD method. Both the initial fresh and the aged solutions contained no nitrosamine (20 ppb detection limit). The above concentrate was treated with 1 g/l of sodium nitrite and aged for 6 months. Again, both the initial fresh and the aged solutions contained no nitrosamine (20 ppb detection limit). When the above concentrate was formulated with 100 grams of triethanolamine and no monoethanolamine, nitrosamine formation was observed in the nitrite treated solution after six months (811 ppb nitros-diethanolamine).

Having described the invention, we now claim the following and their equivalents.

1. A method for inhibiting nitrosamine formation in a waterborne coating formulation containing at least one secondary and/or tertiary amine and a nitrosating agent comprising adding at least one primary amine to said waterborne coating formulation in an amount sufficient to inhibit nitrosamine formation.

2. The method of claim 1 wherein the nitrosating agent is a nitrite salt.

3. The method of claim 1 wherein the secondary and/or tertiary amine is selected from methylaminoethanol, ethylaminoethanol, isopropylaminoethanol, butylaminoethanol, methyldiethanolamine, ethyldiethanolamine, isopropyldiethanolamine, butyldiethanolamine, dimethylaminoethanol, diethylaminoethanol, diisopropylaminoethanol, dibutylaminoethanol, 3-dimethylaminopropylamine, 3-diethylaminopropylamine or mixtures thereof.

4. The method of claim 1 wherein the primary amine has a molecular weight smaller than 300 and wherein the primary amine is preferably non-polymeric.

5. The method of claim 1 wherein the primary amine is selected from monoethanolamine, 2-amino-2-methyl-1-propanol, 3-dimethylaminopropylamine, 3-diethylaminopropylamine or mixtures thereof.

6. The method of claim 1 wherein from about 1% to 100% by weight relative to the amount of said secondary and/or tertiary amine of said primary amine is added to said waterborne coating formulation.

7. The method of claim 1 wherein the waterborne coating formulation is a paint comprising a binder, in particular a polymeric binder, and a pigment.

8. The method of claim 7 wherein said primary amine is added to the formulation after having produced said binder.

9. The method of claim 1 wherein the amount of said primary amine which is added to the waterborne coating formulation is sufficient to inhibit nitrosamine formation when storing the waterborne coating formulation at 120° C. for three days.

10. A waterborne coating formulation containing at least one secondary and/or tertiary amine and a nitrosating agent, which coating composition further comprising an amount of at least one primary amine which is sufficient to inhibit nitrosamine formation, in particular when storing the waterborne coating formulation at 120° C. for three days.

11. The coating formulation of claim 10 wherein the nitrosating agent is a nitrite salt.

12. The coating formulation of claim 10 wherein the secondary and/or tertiary amine is selected from methylaminoethanol, ethylaminoethanol, isopropylaminoethanol, butylaminoethanol, methyldiethanolamine, ethyldiethanolamine, isopropyldiethanolamine, butyldiethanolamine, dimethylaminoethanol, diethylaminoethanol, diisopropylaminoethanol, dibutylaminoethanol, 3-dimethylaminopropylamine, 3-diethylaminopropylamine or mixtures thereof.

13. The coating formulation of claim 10 wherein the primary amine has a molecular weight smaller than 300 and wherein the primary amine is preferably non-polymeric.

14. The coating formulation of claim 13 wherein the primary amine is selected from monoethanolamine, 2-amino-2-methyl-1-propanol, 3-dimethylaminopropylamine, 3-diethylaminopropylamine or mixtures thereof.

15. The coating formulation of claim 10 which contains from about 1% to 100% by weight relative to the amount of said secondary and/or tertiary amine of said primary amine.

16. The coating formulation of claim 10 wherein the waterborne coating formulation is a paint comprising a binder, in particular a polymeric binder, and a pigment.

17. The coating formulation of claim 10 wherein said primary amine is water soluble.
